(19) United States
(12) Patent Application Publication
(10) Pub. No.: US 2015/0106729 A1
(43) Pub. Date: Apr. 16, 2015

(54) REMOTELY CONTROLLING ONE OR MORE DISPLAY UNIT(S) COMMUNICATIVELY COUPLED TO A DATA PROCESSING DEVICE AND/OR DISPLAY DATA RENDERED THEREON

(71) Applicant: NVIDIA Corporation, Santa Clara, CA (US)

(72) Inventor: Harsha Kumar, Pune (IN)

(73) Assignee: NVIDIA Corporation, Santa Clara, CA (US)

(21) Appl. No.: 14/054,878

(22) Filed: Oct. 16, 2013

(51) Int. Cl. H04L 29/08; G06F 3/0484

(52) U.S. Cl. CPC H04L 67/025; G06F 3/0484
USPC 715/740

(57) ABSTRACT

A method includes executing a process on a data processing device, and defining, through a driver component, mapping between: the process and a display unit communicatively coupled to the data processing device, and one or more other processes executing on the data processing device and one or more other display unit(s) communicatively coupled to the data processing device. Based on the execution of the process on the data processing device, the method also includes providing a capability to: preview display data rendered on the one or more other display unit(s) through the display unit in a user interface provided through the process, and configure the display data rendered on the one or more other display unit(s) and/or one or more parameter(s) associated with the display data rendered on the one or more other display unit(s) and/or the one or more other display unit(s) directly through the preview.

### FIELD OF TECHNOLOGY

This disclosure relates generally to data processing devices and, more particularly, to a method, a device and/or a system of remotely controlling one or more display unit(s) communicatively coupled to a data processing device and/or display data rendered thereon.

### BACKGROUND

A data processing device (e.g., a desktop computer, a laptop computer, a notebook computer, a netbook, a mobile device such as a mobile phone or a tablet) may have multiple display units communicatively coupled thereto. One display unit may be at a location of a user of the data processing device and another display unit may be remote from the location of the user; for example, the another display unit may be communicatively coupled to the data processing device through a computer network. In order to determine proper execution of application(s) assigned to the pipeline associated with the another display unit, the user may have to move to the remote location and/or leverage another user at the remote location. The aforementioned arrangement may severely inconvenience the user.

### SUMMARY

Disclosed are a method, a device and/or a system of remotely controlling one or more display unit(s) communicatively coupled to a data processing device and/or display data rendered thereon.

In one aspect, a method includes executing a process on a data processing device, and defining, through a driver component, mapping between: the process and a display unit communicatively coupled to the data processing device, and one or more other processes executing on the data processing device and one or more other display unit(s) communicatively coupled to the data processing device. Based on the execution of the process on the data processing device, the method also includes providing a capability to: preview display data rendered on the one or more other display unit(s) through the display unit in a user interface provided through the process, and configure the display data rendered on the one or more other display unit(s) and/or one or more parameter(s) associated with the display data rendered on the one or more other display unit(s) and/or the one or more other display unit(s) directly through the preview.

In another aspect, a non-transitory medium, readable through a data processing device and including instructions embodied therein that are executable through the data processing device, is disclosed. The non-transitory medium includes instructions to execute a process on the data processing device, and instructions to define, through a driver component, mapping between: the process and a display unit communicatively coupled to the data processing device, and one or more other processes executing on the data processing device and one or more other display unit(s) communicatively coupled to the data processing device. Based on the execution of the process on the data processing device, the non-transitory medium also includes instructions to provide a capability to: preview display data rendered on the one or more other display unit(s) through the display unit in a user interface provided through the process, and configure the display data rendered on the one or more other display unit(s) and/or one or more parameter(s) associated with the display data rendered on the one or more other display unit(s) and/or the one or more other display unit(s) directly through the preview.

In yet another aspect, a data processing device includes a memory and a processor communicatively coupled to the memory. The processor is configured to execute instructions associated with a process and one or more other processes. The data processing device also includes a driver component to define mapping between: the process and a display unit communicatively coupled to the data processing device, and the one or more other processes and one or more other display unit(s) communicatively coupled to the data processing device. The execution of the process is configured to provide a capability to: preview display data rendered on the one or more other display unit(s) through the display unit in a user interface provided through the process, and configure the display data rendered on the one or more other display unit(s) and/or one or more parameter(s) associated with the display data rendered on the one or more other display unit(s) and/or the one or more other display unit(s) directly through the preview.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is an illustrative view of a user interface provided by an application executing on the data processing device of FIG. 1.

FIG. 3 is an illustrative view of virtual desktop background surfaces on which display data is overlaid and scaled versions thereof overlaid on a preview provided through the user interface of FIG. 2, according to one or more embodiments.

FIG. 4 is an illustrative view of transfer of a file stored in a memory of the data processing device of FIG. 1 from display data associated with one display unit to display data associated with another display unit directly through the preview of FIG. 3, according to one or more embodiments.

FIG. 5 is an illustrative view of transfer of data from display data associated with a display unit through which the preview of FIG. 3 is viewable to display data associated with another display unit directly through the preview of FIG. 3, according to one or more embodiments.

FIG. 6 is a process flow diagram detailing the operations involved in remotely controlling the display units communicatively coupled to the data processing device of FIG. 1 and/or display data rendered thereon, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of remotely controlling one or more display unit(s) communicatively coupled to a data processing device and/or display data rendered thereon. Although the present embodiments have been described with reference to specific example embodiments, it will be evident that various modifications and changes may be made to these embodiments without departing from the broader spirit and scope of the various embodiments.

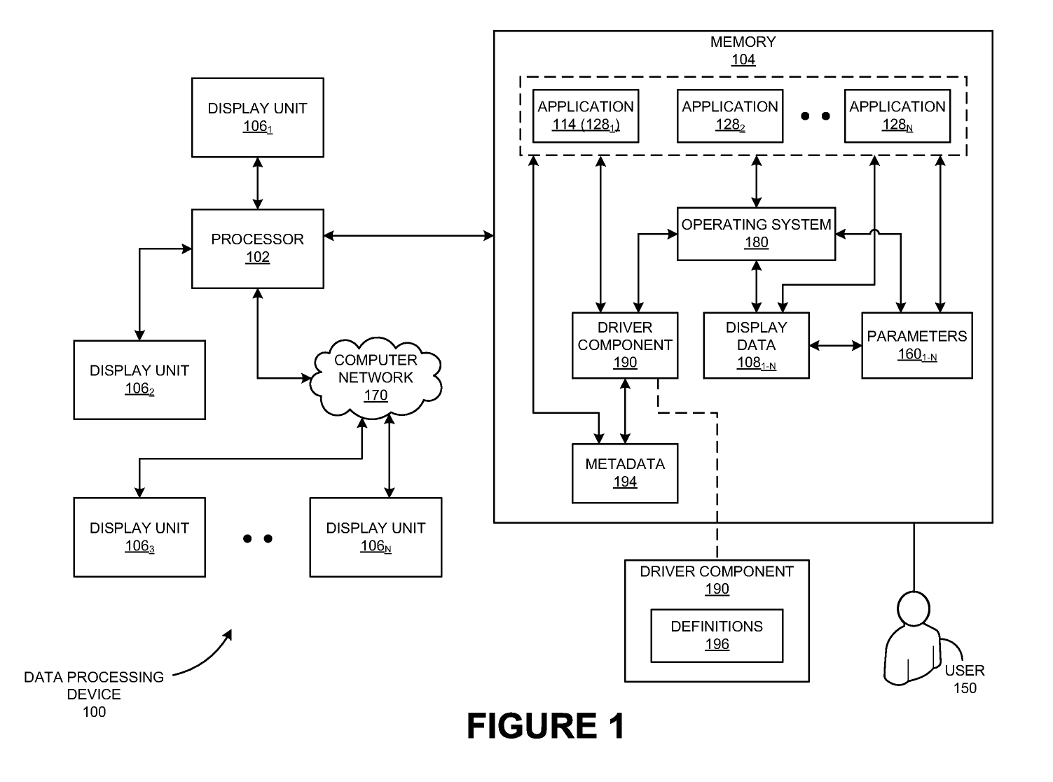

FIG. 1 shows a data processing device 100, according to one or more embodiments. In one or more embodiments, data processing device 100 may be a desktop computer, a laptop computer, a notebook computer, a netbook or a mobile device such as a mobile phone or a tablet. Other forms of data processing device 100 are within the scope of the exemplary embodiments discussed herein. In one or more embodiments, data processing device 100 may include a processor 102 (e.g., a Central Processing Unit (CPU) and/or a Graphics Processing Unit (GPU)) communicatively coupled to a memory 104 (e.g., a volatile memory and/or a non-volatile memory); memory 104 may include storage locations addressable through processor 102.

In one or more embodiments, data processing device 100 may include a number of display units 106_{1-N} (e.g., Cathode Ray Tube (CRT) displays, Liquid Crystal Displays (LCDs)) configured to have display data output from processor 102 rendered thereon. FIG. 1 shows display units 106_{1-N} directly interfaced with data processing device 100 and interfaced with data processing device 100 through a computer network 170 (e.g., a wired and/or a wireless network such as a home network (e.g., Bluetooth®, Wi-Fi Direct®), a Local Area Network (LAN) and a Wide Area Network (WAN)). In one or more embodiments, data processing device 100 may execute an instance of a process (e.g., application 114 shown as being stored in memory 104) thereon to enable configuration of display data 108_{2-N} and/or one or more parameter(s) 160_{2-N} (e.g., display resolution, pixel resolution) associated with display data 108_{2-N} and/or display units 106_{2-N} through a user interface provided by the process; here, the user interface may be associated with display data 108₁ corresponding to display unit 106₁. An example application 114 may be a modified version of NVIDIA® Control Panel configured to control GPUs and Mobile Communication Processors (MCPs).

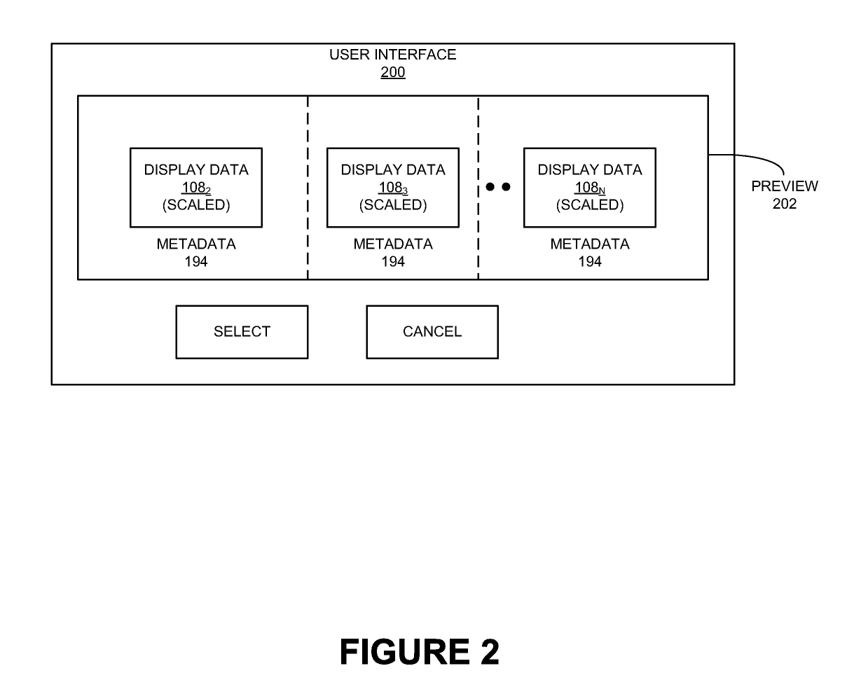

FIG. 1 shows display data 108_{1-N} and parameters 160_{1-N} as being stored in memory 104. FIG. 1 also shows an operating system 180 executing on data processing device 100; operating system 180 is also shown as being stored in memory 104. A user 150 of data processing device 100 may be able preview display data 108_{2-N} associated with display units 106_{2-N} coupled to data processing device 100 through the user interface (discussed above) provided by application 114 viewable through display unit 106₁; here, it is obvious that display unit 106₁ is at the location of user 150. FIG. 2 shows a user interface 200 provided through application 114, according to one or more embodiments. In one or more embodiments, user interface 200 may provide a preview 202 of display data 108_{2-N} associated with display units 106_{2-N} coupled to data processing device 100. In addition, in one or more embodiments, user 150 may be able to edit display data 108_{2-N} rendered on display units 106_{2-N} and/or one or more parameter(s) 160_{2-N} associated with display data 108_{2-N} and/or display units 106_{2-N} directly through preview 202.

Referring back to FIG. 1, memory 104 may include a driver component 190 stored therein. In one or more embodiments, driver component 190 may be associated with processor 102 and/or one or more display unit(s) 106_{1-N}. In one or more embodiments, driver component 190 may be packaged with application 114 and/or operating system 180. Alternately, driver component 190 may, for example, be downloaded from the Internet and installed on data processing device 100. Further, instructions associated with driver component 190 and/or application 114 may be embodied on a non-transitory medium (e.g., a Compact Disc (CD), a Digital Video Disc (DVD), a Blu-ray Disc®, a hard drive) readable through data processing device 100 and executable therethrough. All reasonable variations are within the scope of the exemplary embodiments discussed herein.

In one or more embodiments, driver component 190 may provide metadata information associated with display units 106_{2-N}; for example, processor 102 may trigger execution of instructions associated with driver component 190 to extract the aforementioned metadata information (e.g., metadata 194 shown as being stored in memory 104). The aforementioned metadata information (e.g., model name/information associated with display units 106_{2-N}) may be applied to preview 202 to enable user 150 be aware of display units 106_{2-N} coupled to data processing device 100 and identify the corresponding display data 108_{2-N} associated therewith.

In one or more embodiments, driver component 190 may include definitions 196 associated with the mapping between processes (e.g., applications 128_{2-N}; application 114 may be regard as application 128₁) executing on data processing device 100 and display units 106_{1-N}. For example, a gaming application may be rendered along with display data 108₂ on one display unit 106₂ and a word processing application on another display unit 106₃. Alternately, display data 108₃ associated with one display unit 106₃ may be spanned/cloned across another display unit 106₄. Operating system 180 may provide a virtual desktop background surface on which display data 108_{1-N} associated with each display unit 106_{1-N} is overlaid. In the case of spanning of display data 108₃ rendered on one display unit 106₃ across another display unit 106₄, driver component 190 may include definitions (e.g., definition(s) 196) associated with distributing the virtual desktop background surface across display unit 106₃ and display unit 106₄.

Again, in one or more embodiments, application 114 may leverage the virtual desktop background surfaces provided by operating system 180 on which display data 108_{2-N} is overlaid and apply a scaled version thereof onto preview 202. In one or more embodiments, for the aforementioned purpose, the execution of instructions associated with application 114 may cause processor 102 to scale display data 108_{2-N} being rendered on display units 106_{2-N} appropriately to fit the scaled versions of the virtual desktop background surfaces in preview 202.

It should be noted that definitions 196 in driver component 190 may include the mapping between application 114 and display unit 106₁, thereby enabling user 150 view preview 202 on display unit 106₁.

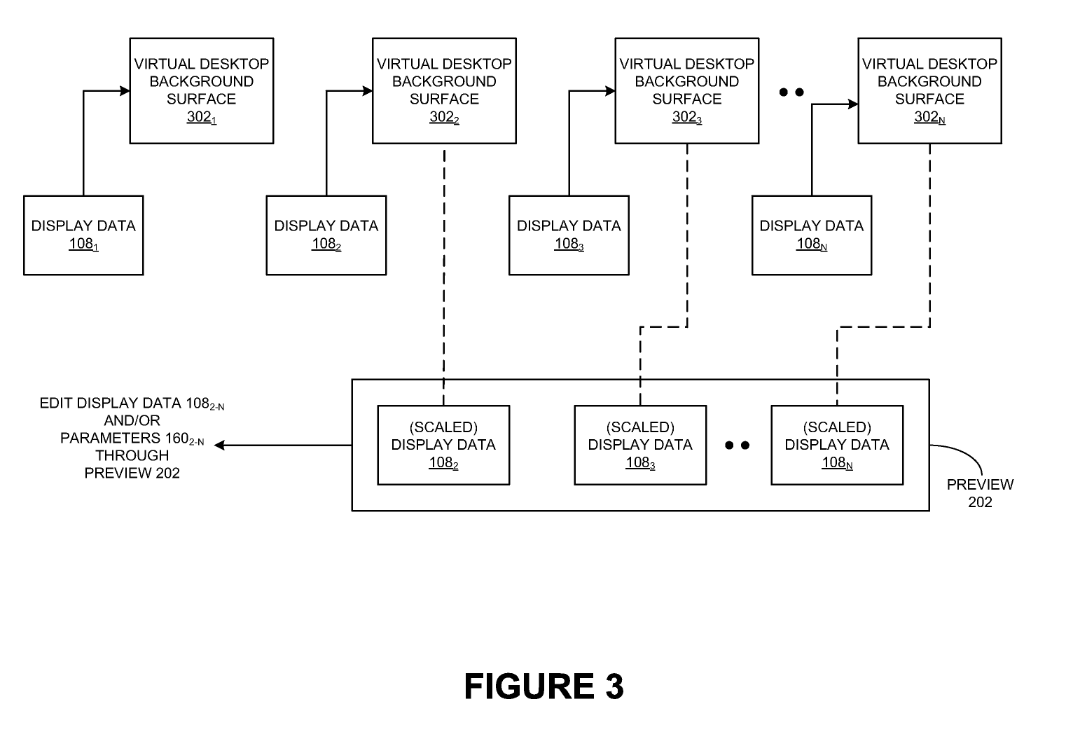

FIG. 3 show virtual desktop background surfaces 302_{2-N} (virtual desktop background surface 302₁ is associated with display data 108₁) on which display data 108_{2-N} is overlaid and scaled versions thereof overlaid on preview 202, according to one or more embodiments. In one or more embodiments, the scaled versions of display data 108_{2-N} may render it possible for user 150 to edit display data 108_{2-N} through preview 202 and/or one or more parameter(s) 160_{2-N} associated with display data 108_{2-N} and/or display units 106_{2-N}. Also, in one or more embodiments, user 150 may be able to check if a display unit 106_{2-N} is ON or OFF through preview 202. Further, user 150 may be able to diagnose failure(s) associated with rendering display data 108_{2-N} on display units 106_{2-N} through preview 202. For example, the space on preview 202 associated with a display unit 106_{2-N} being blank may indicate a faulty coupling of the corresponding display unit 106_{2-N} to data processing device 100 and/or a faulty definition 196 in driver component 190.

Thus, in one or more embodiments, when multiple display units 106_{1-N} are coupled to processor 102, user 150 may perform functions such as resizing windows, changing orientations of the windows and enabling three dimensional (3D) content as part of editing display data 108_{2-N}, and changing pixel resolution and display resolution as part of editing parameters 160_{2-N}. Other examples (e.g., clearing display data 108_{2-N}, operating a display unit 106_{2-N} in a power savings mode) are within the scope of the exemplary embodiments discussed herein. The aforementioned editing may be possible because both the scaled versions of display data 108_{2-N} and display data 108_{2-N} may be mapped as processing outputs (e.g., output data from processor 102) such that modifying one (e.g., a scaled version of display data 108_{2-N}) also results in the modification of the other (e.g., display data 108_{2-N}).

In one or more embodiments, user 150 may also perform inter-display data 108_{2-N} functionalities such as transferring/copying data (e.g., a file) from one set of display data 108_{2-N} (e.g., display data 108₃) to another (e.g., display data 108₂). The aforementioned may merely require a drag and drop operation to be performed by user 150. Further, in one or more embodiments, data may also be transferred/copied from display data 108₁ being rendered on display unit 106₁ through which preview 202 is viewable to another set of display data 108_{2-N} (e.g., a scaled version of display data 108₄) in preview 202. Other inter-display data 108_{1-N}/inter-display unit 106_{1-N} functionalities are within the scope of the exemplary embodiments discussed herein.

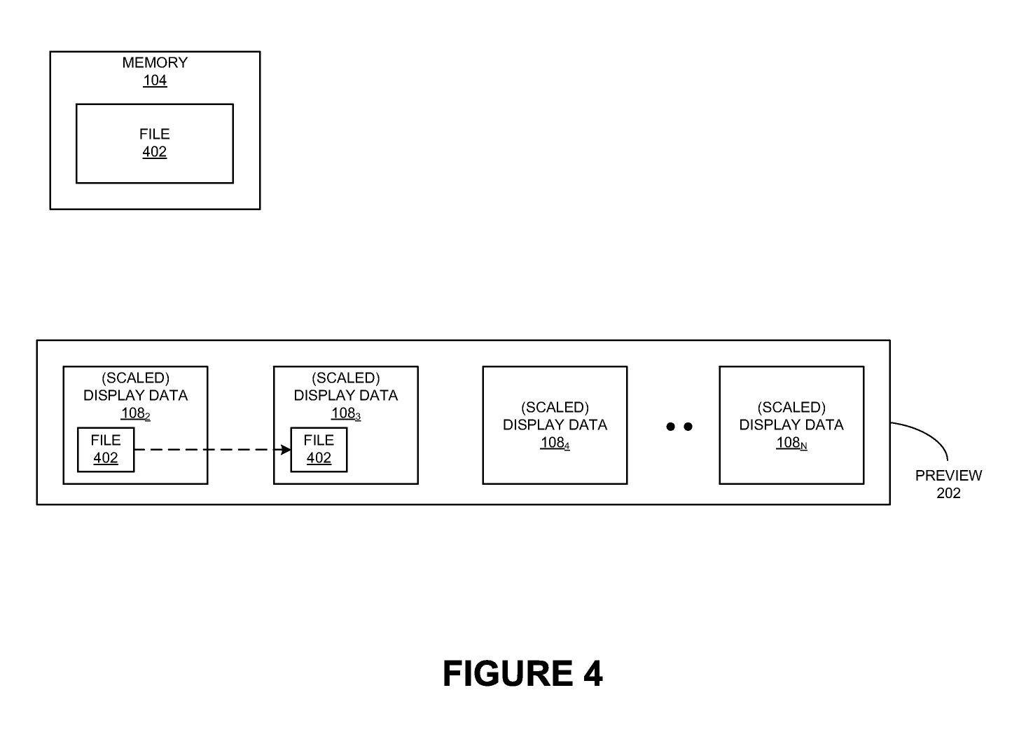

FIG. 4 shows transfer of a file 402 stored in memory 104 from display data 108₂ associated with display unit 106₂ to display data 108₃ associated with display unit 106₃ directly through preview 202. Effectively, the aforementioned transfer may equate to file 402 being moved from a spatial location on virtual desktop background surface 302₂ to a spatial location on virtual desktop background surface 302₃. It is obvious that items such as active windows may also be moved across display data 108_{1-N}. When data is moved across display data 108_{1-N}, a location thereof in memory 104 may be modified; in addition, operating system 180 (shown in FIG. 1 as being interfaced with application 114), for example, may be aware of definitions 196 in driver component 190, which may be appropriately modified.

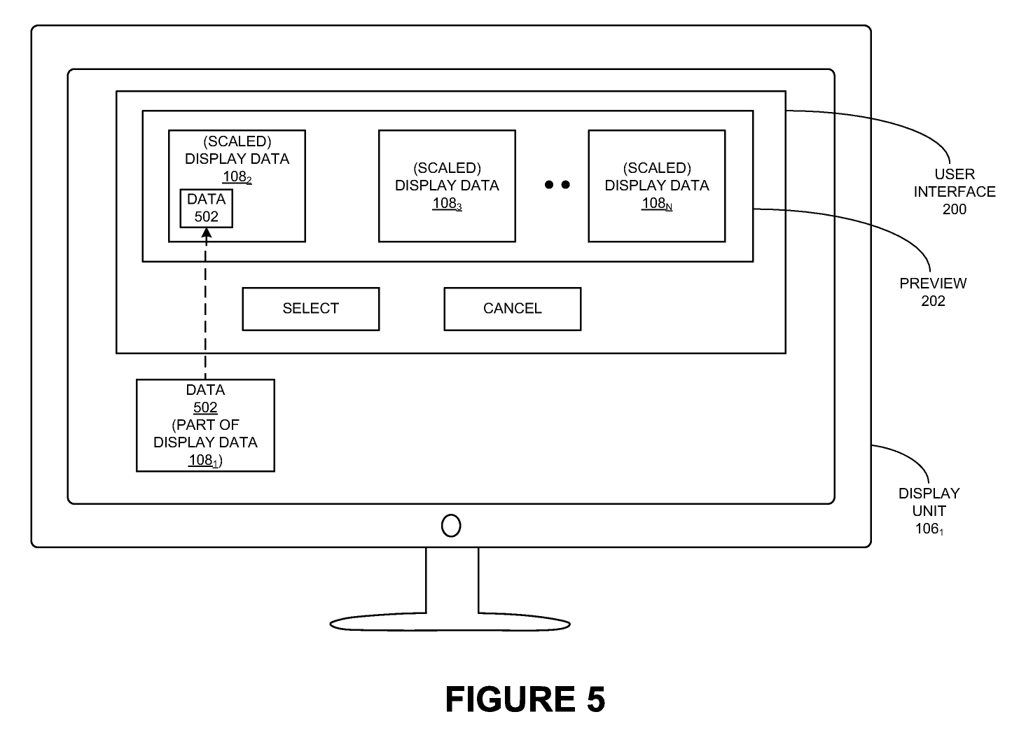

FIG. 5 shows transfer of data 502 from display data 108₁ rendered on display unit 106₁ to display data 108₂ associated with display unit 106₂ directly through preview 202. It should be noted that in all the cases, application 114 may trigger processor 102 to transmit scaled versions of display data 108_{1-N} that are fit into scaled versions of virtual desktop background surfaces 302_{2-N} within preview 202. Further, it should be noted that data may be transferred from display data 108_{2-N} (or, scaled versions thereof) to display data 108₁ rendered on display unit 106₁ directly through preview 202.

Thus, exemplary embodiments may enable user 150 be aware of content being rendered on display units 106_{2-N} remote from data processing device 100. In one or more embodiments, as mentioned above, user 150 may be able to edit display data 108_{2-N} and/or parameters associated with display data 108_{2-N} and/or display units 106_{2-N} directly through preview 202, which provides for remote control of display units 106_{2-N} and/or display data 108_{2-N} associated therewith. User 150 may not be required to move to a remote location of a display unit 106_{2-N} and/or utilize another user at the remote location to confirm the dynamic modification of display data 108_{2-N} associated therewith.

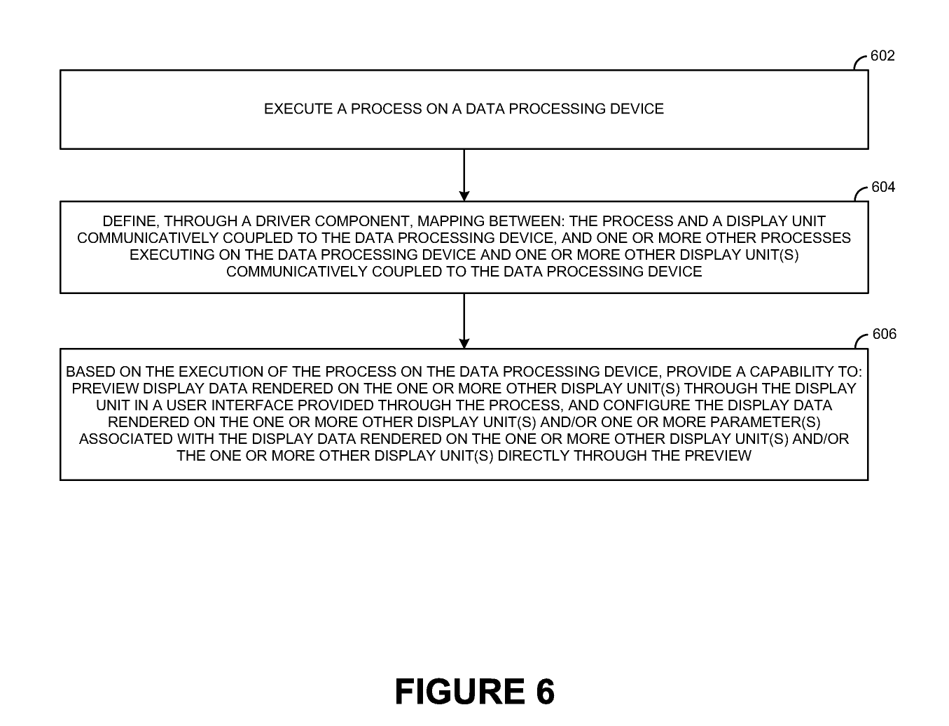

FIG. 6 shows a process flow diagram detailing the operations involved in remotely controlling display units 106_{2-N} communicatively coupled to data processing device 100 and/or display data 108_{2-N} rendered thereon, according to one or more embodiments. In one or more embodiments, operation 602 may involve executing a process (e.g., application 114) on data processing device 100. In one or more embodiments, operation 604 may involve defining, through driver component 190, mapping between: the process and display unit 106₁ communicatively coupled to data processing device 100, and one or more other processes (e.g., applications 128_{2-N}) executing on data processing device 100 and one or more other display unit(s) 106_{2-N} communicatively coupled to data processing device 100.

In one or more embodiments, operation 606 may involve providing, based on the execution of the process on data processing device 100, a capability to: preview (e.g., preview 202) display data 108_{2-N} rendered on the one or more other display unit(s) 106_{2-N} through display unit 106₁ in user interface 200 provided through the process, and configure display data 108_{2-N} rendered on the one or more other display unit(s) 106_{2-N} and/or one or more parameter(s) 160_{2-N} associated with display data 108_{2-N} and/or the one or more other display unit(s) 106_{2-N} directly through preview 202.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

What is claimed is:

1. A method comprising:
executing a process on a data processing device;
defining, through a driver component, mapping between:
the process and a display unit communicatively coupled to the data processing device; and
at least one other process executing on the data processing device and at least one other display unit communicatively coupled to the data processing device; and
based on the execution of the process on the data processing device, providing a capability to:
preview display data rendered on the at least one other display unit through the display unit in a user interface provided through the process; and
configure at least one of: the display data rendered on the at least one other display unit and at least one parameter associated with at least one of: the display data rendered on the at least one other display unit and the at least one other display unit directly through the preview.

2. The method of claim 1, further comprising providing, through the driver component, metadata information associated with the at least one other display unit to be applied to the preview.

3. The method of claim 1, wherein providing the capability to preview the display data rendered on the at least one other display unit further comprises applying, through a processor of the data processing device communicatively coupled to a memory, a scaled version of: at least one virtual desktop background surface provided by an operating system executing on the data processing device on which the display data is rendered and the display data within the preview, based on the execution of the process.

4. The method of claim 3, further comprising mapping the scaled version of the display data and the display data as an output of the processor such that modifying one of: the scaled version of the display data and the display data also results in the modification of the other of: the scaled version of the display data and the display data.

5. The method of claim 1, further comprising providing a capability to transfer data between display data associated with the display unit and the display data associated with the at least one other display unit directly through the preview.

6. The method of claim 1, wherein when the at least one other display unit is a plurality of display units, the method further comprises providing a capability to transfer data between display data associated with one display unit of the plurality of display units and display data associated with another display unit of the plurality of display units directly through the preview.

7. The method of claim 1, comprising at least one of:
executing an application as the process executing on the data processing device; and
providing the driver component packaged with at least one of an operating system executing on the data processing device and the application.

8. A non-transitory medium, readable through a data processing device and including instructions embodied therein that are executable through the data processing device, comprising:
instructions to execute a process on the data processing device;
instructions to define, through a driver component, mapping between:
the process and a display unit communicatively coupled to the data processing device; and
at least one other process executing on the data processing device and at least one other display unit communicatively coupled to the data processing device; and
based on the execution of the process on the data processing device, instructions to provide a capability to:
preview display data rendered on the at least one other display unit through the display unit in a user interface provided through the process; and
configure at least one of: the display data rendered on the at least one other display unit and at least one parameter associated with at least one of: the display data rendered on the at least one other display unit and the at least one other display unit directly through the preview.

9. The non-transitory medium of claim 8, further comprising instructions to provide, through the driver component, metadata information associated with the at least one other display unit to be applied to the preview.

10. The non-transitory medium of claim 8, wherein the instructions to provide the capability to preview the display data rendered on the at least one other display unit further comprise instructions to apply, through a processor of the data processing device communicatively coupled to a memory, a scaled version of: at least one virtual desktop background surface provided by an operating system executing on the data processing device on which the display data is rendered and the display data within the preview, based on the execution of the process.

11. The non-transitory medium of claim 10, further comprising instructions to map the scaled version of the display data and the display data as an output of the processor such that modifying one of: the scaled version of the display data and the display data also results in the modification of the other of: the scaled version of the display data and the display data.

12. The non-transitory medium of claim 8, further comprising instructions to provide a capability to transfer data between display data associated with the display unit and the display data associated with the at least one other display unit directly through the preview.

13. The non-transitory medium of claim 8, wherein when the at least one other display unit is a plurality of display units, the non-transitory medium further comprises instructions to provide a capability to transfer data between display data associated with one display unit of the plurality of display units and display data associated with another display unit of the plurality of display units directly through the preview.

14. A data processing device comprising:
a memory;
a processor communicatively coupled to the memory, the processor being configured to execute instructions associated with a process and at least one other process; and
a driver component to define mapping between:
the process and a display unit communicatively coupled to the data processing device, and
the at least one other process and at least one other display unit communicatively coupled to the data processing device,
wherein the execution of the process is configured to provide a capability to:
preview display data rendered on the at least one other display unit through the display unit in a user interface provided through the process, and
configure at least one of: the display data rendered on the at least one other display unit and at least one parameter associated with at least one of: the display data rendered on the at least one other display unit and the at least one other display unit directly through the preview.

15. The data processing device of claim 14, wherein the driver component is further configured to provide metadata information associated with the at least one other display unit to be applied to the preview.

16. The data processing device of claim 14, wherein the processor is configured to execute instructions to apply a scaled version of: at least one virtual desktop background surface provided by an operating system executing on the data processing device on which the display data is rendered and the display data within the preview, based on the execution of the process.

17. The data processing device of claim 16, wherein the scaled version of the display data and the display data are mapped as an output of the processor such that modifying one of: the scaled version of the display data and the display data also results in the modification of the other of: the scaled version of the display data and the display data.

18. The data processing device of claim 14, wherein the execution of the process further provides a capability to transfer data between display data associated with the display unit and the display data associated with the at least one other display unit directly through the preview.

19. The data processing device of claim 14, wherein when the at least one other display unit is a plurality of display units, the execution of the process further provides a capability to transfer data between display data associated with one display unit of the plurality of display units and display data associated with another display unit of the plurality of display units directly through the preview.

20. The data processing device of claim 14, wherein at least one of:
the process executing on the data processing device is an application, and
the driver component is provided packaged with at least one of an operating system executing on the data processing device and the application.
